(19) United States
(12) Patent Application Publication
(10) Pub. No.: US 2010/0238485 A1
(43) Pub. Date: Sep. 23, 2010

(54) STORAGE MEDIUM STORING PRINT MANAGEMENT PROGRAM, PRINT MANAGEMENT APPARATUS, AND PRINTER SYSTEM

(75) Inventor: Shinichi Miyamoto, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI XEROX CO., LTD., Tokyo (JP)

(21) Appl. No.: 12/546,067

(22) Filed: Aug. 24, 2009

(30) Foreign Application Priority Data
Mar. 17, 2009 (JP) 2009-064785

(51) Int. Cl. G06F 3/12

(52) U.S. Cl. 358/1.15

(57) ABSTRACT

A print management apparatus is provided. A print history of a print job data is stored into a first storage component, when a print data identifier of the print job data containing print data, a print data identifier, and a printing parameter is not stored in the first storage component. A printing parameter in the first storage component served as alert information is stored into a second storage component as an alert history, when the print data identifier of the print job data is stored in the first storage component, and a printing parameter stored in the first storage component is not the same as a printing parameter of the print job data. Whether continuing a print or aborting a print is selected, when the print data identifier of the print job data is stored in the second storage component.

### CROSS-REFERENCE TO RELATED APPLICATIONS

This application is based on and claims priority under 35 USC 119 from Japanese Patent Application No. 2009-064785 filed Mar. 17, 2009.

### BACKGROUND

1. Technical Field

The present invention relates to a storage medium storing a print management program, a print management apparatus, and a printer system.

2. Related Art

Conventionally, there have been known a print control apparatus that prevents repetitive print failures and a print control system that copes with cases where printing is aborted.

### SUMMARY

According to an aspect of the invention, there is provided a print management apparatus that includes: a first storage component that stores a print history associated with a print data identifier for identifying print data and a printing parameter to be used to perform printing based on the print data; a second storage component that stores an alert history associated with the print data identifier and alert information; a first control component that performs a control operation to store the print history of the print job data into the first storage component, when the print data identifier of the print job data containing the print data, the print data identifier, and the printing parameter is not stored in the first storage component; a second control component that performs a control operation to store an alert history including a printing parameter stored as alert information in the first storage component into the second storage component, when the print data identifier of the print job data is stored in the first storage component, and a printing parameter stored in the first storage component is not the same as a printing parameter of the print job data; a select component that prompts a user to select a print continue command or a print abort command, when the print data identifier of the print job data is stored in the second storage component; and a print control component that controls the printing, based on the select result of the select component.

### BRIEF DESCRIPTION OF THE DRAWINGS

Exemplary embodiments of the present invention will be described in detail based on the following figures, wherein:

FIG. 1 is a block diagram showing an example of a main portion structure of the electrical system of a printer system in accordance with a first exemplary embodiment of the invention;

FIG. 2 is a schematic view showing an example of the entire operation flow of the printer system in accordance with the first exemplary embodiment of the invention;

FIG. 3 is a flowchart showing an example of the processing flow of a computer in the printer system in accordance with the first exemplary embodiment of the invention;

FIG. 4 is a flowchart showing an example of the processing flow of the printer server in the printer system in accordance with the first exemplary embodiment of the invention;

FIG. 5 is a flowchart showing an example of the processing flow of the print history storing process in the printer system in accordance with the first exemplary embodiment of the invention;

FIG. 6 is a block diagram showing an example of a main portion structure of the electrical system of a printer system in accordance with a second exemplary embodiment of the invention;

FIG. 7 is a flowchart showing an example of the processing flow of a computer in the printer system in accordance with the second exemplary embodiment of the invention;

FIG. 8 is a flowchart showing an example of the processing flow of the printer in the printer system in accordance with the second exemplary embodiment of the invention;

FIG. 9 is a flowchart showing an example of the processing flow of a computer in a printer system in accordance with a third exemplary embodiment of the invention;

FIG. 10 is a flowchart showing an example of the processing flow of the printer server in a printer system in accordance with a fourth exemplary embodiment of the invention;

FIG. 11 is a flowchart showing an example of the processing flow of the printer server in a printer system in accordance with a fifth exemplary embodiment of the invention;

FIG. 12 is a flowchart showing an example of the processing flow of the printer server in a printer system in accordance with a sixth exemplary embodiment of the invention; and

FIG. 13 is a flowchart showing an example of the processing flow of the print history storing process in the printer system in accordance with the sixth exemplary embodiment of the invention.

### DETAILED DESCRIPTION

The following is a description of exemplary embodiments of the present invention, with reference to the accompanying drawings.

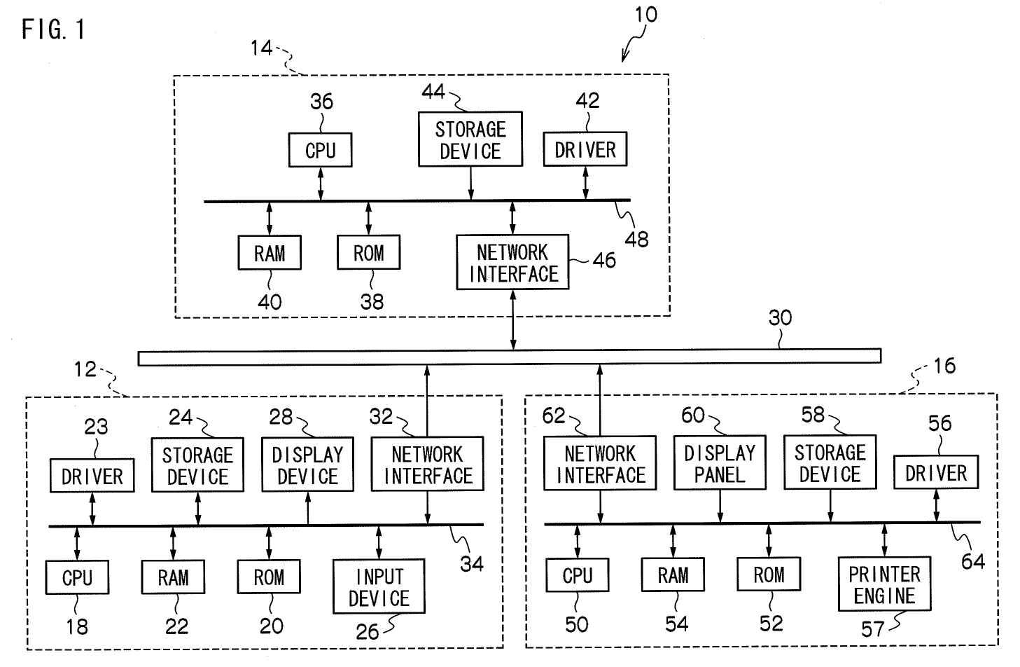

FIG. 1 is a block diagram showing an example of a main portion structure of the electrical system of a printer system 10 in accordance with a first exemplary embodiment.

As shown in FIG. 1, the printer system 10 includes computers 12 that transmit print job data, a printer server 14 that manages an image forming operation based on the transmitted print job data, and a printer 16 that performs the image forming operation based on the print job data.

Each computer 12 includes a CPU (Central Processing Unit) 18 that performs various kinds of control operations, a ROM 20 that stores various kinds of control programs to be executed by the CPU 18 and stores various kinds of data, a RAM (Random Access Memory) 22 that is temporarily used as the work storage area in various operations, a driver 23 that performs data and command reading/writing on a storage medium such as a CD-ROM, an OS (Operating System), a printer driver that sets the various functions of the printer 16, a storage device 24 that stores various application programs, and a keyboard and a mouse. The computer 12 also includes a network interface 32 that is connected to an input device 26 that inputs various kinds of information such as a print continue command and a print abort command, a display device 28 that displays various kinds of information such as an alert dialog, and a network 30. When communications with the printer server 14 and the printer 16 are performed via the network 30, the network interface 32 exchanges various kinds of information with the printer server 14 and the printer 16. Those components of the computer 12 are electrically connected via a system bus 34.

The printer server 14 includes a CPU 36 that performs various kinds of control operations, a ROM 38 that stores various kinds of control programs to be executed by the CPU 36 and various kinds of data, a RAM 40 that is temporarily used as the work storage area in various kinds of operations, a driver 42 that performs data and command reading/writing on a storage medium such as a CD-ROM, a storage device 44 that stores the later described print history table, the later described print failure table, and the likes, and a network interface 46 that is connected to the network 30 and exchanges various kinds of information with the computer 12 and the printer 16 when communications with the computer 12 and the printer 16 are performed via the network 30. Those components of the printer server 14 are electrically connected via a system bus 48.

The printer 16 includes a CPU 50 that performs various kinds of control operations, a ROM 52 that stores various kinds of control programs to be executed by the CPU 50 and various kinds of data, a RAM 54 that is temporarily used as the work storage area in various kinds of operations, a driver 56 that performs data and command reading/writing on a storage medium such as a memory card, a printer engine 57 that forms an image on a recording medium based on print job data designating a print job, a storage device 58 that stores a device controller for controlling the operation of the printer engine 57, a display panel 60 that displays various kinds of information, and a network interface 62 that is connected to the network 30 and exchanges various kinds of information with the computer 12 and the printer server 14 when communications with the computer 12 and the printer server 14 are performed via the network 30. Those components of the printer 16 are electrically connected via a system bus 64.

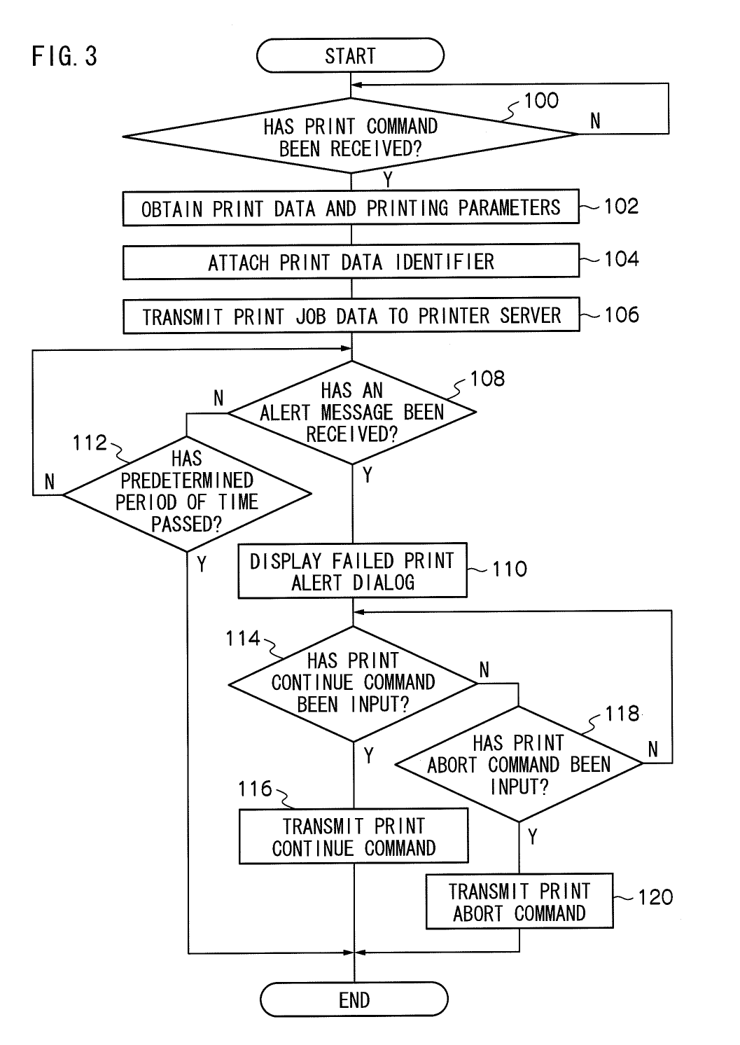

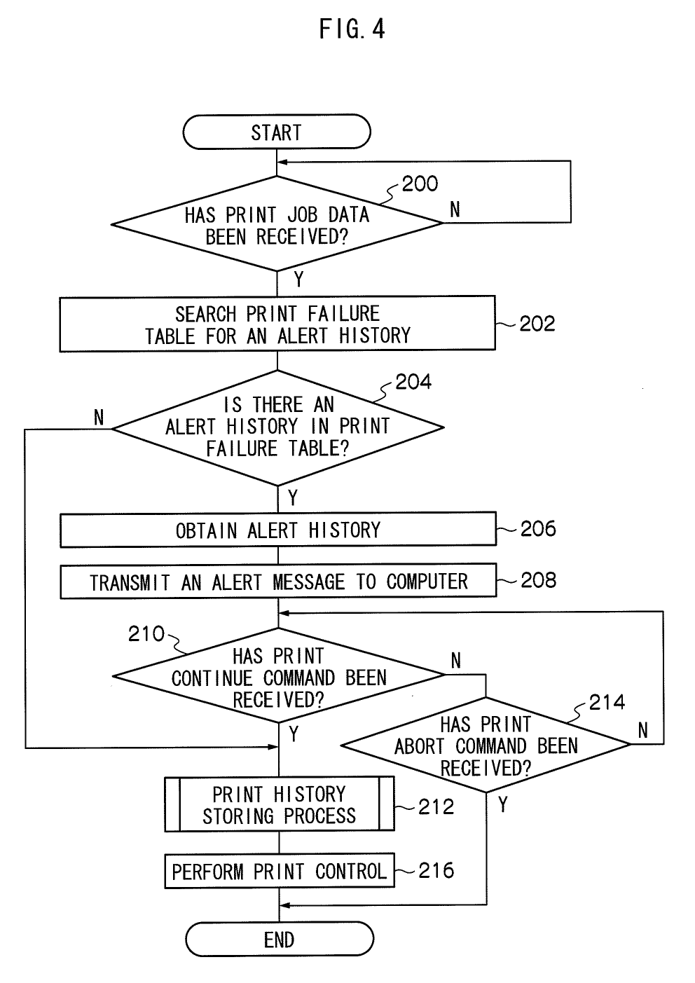

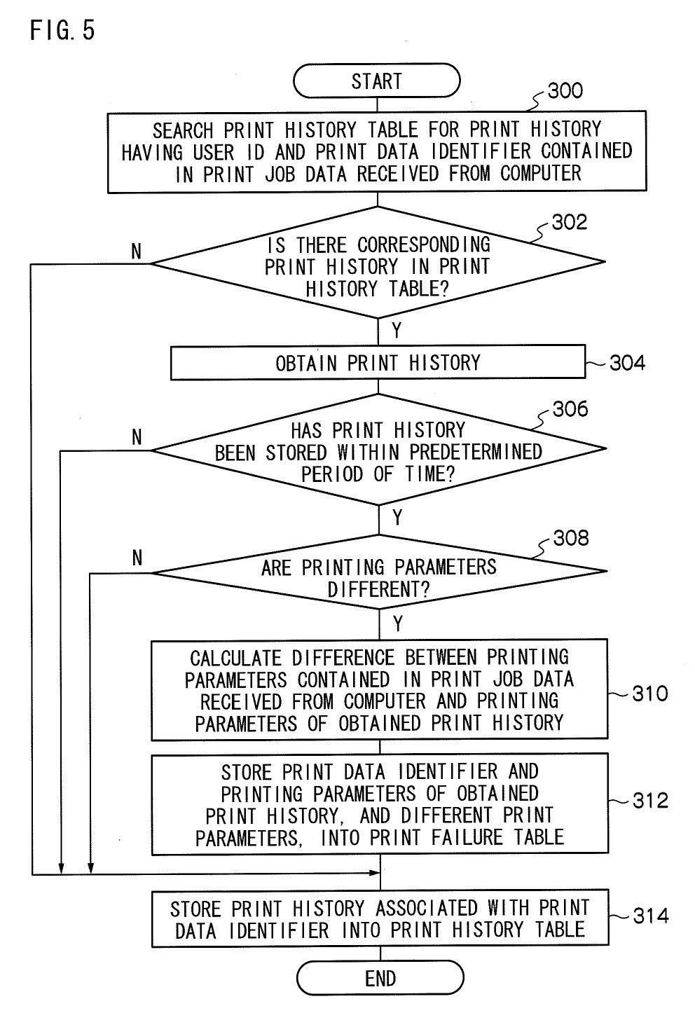

The later described processing routine program illustrated in FIG. 3 is stored in the ROM 20 as the storage medium of the computer 12, and the later described processing routine program illustrated in FIGS. 4 and 5 is stored in the ROM 38 as the storage medium of the printer server 14.

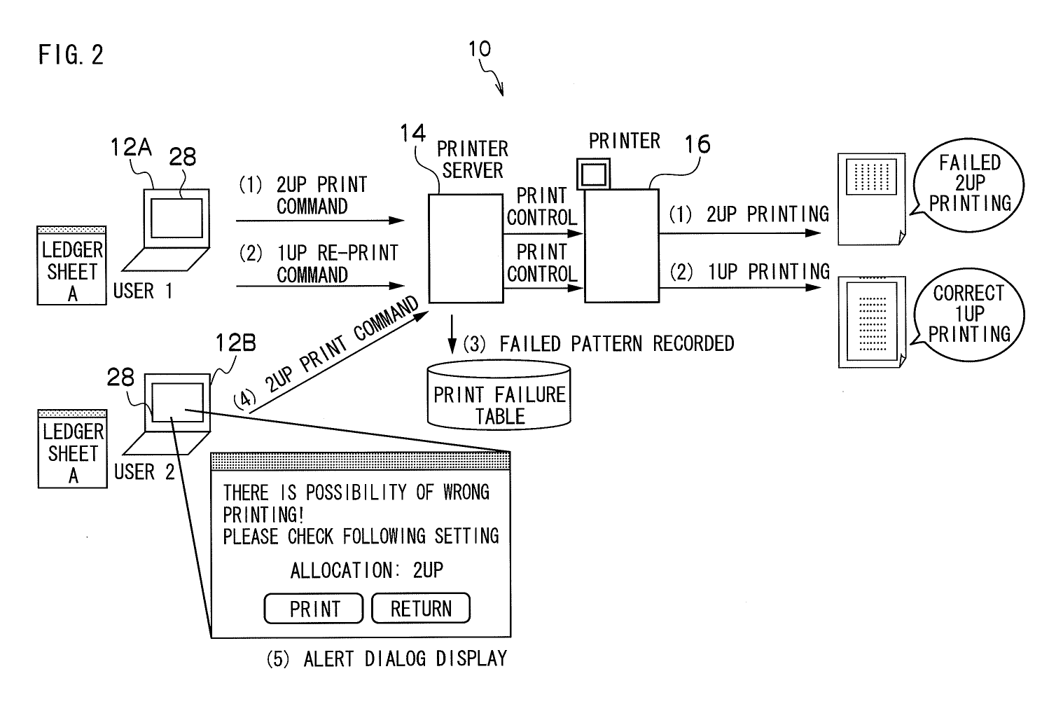

Referring now to FIG. 2, an example of the processing flow in the printer system 10 of this exemplary embodiment is briefly described through an example case where a user 1 and a user 2 perform printing operations with the use of the printer system 10 in accordance with this exemplary embodiment.

First, the user 1 transmits a print command from the computer 12A to the printer server 14 to collectively print a 2-page ledger sheet A onto one paper sheet (hereinafter referred to as “2UP”printing). In this case, the printer server 14 performs print control on the printer 16, and the printer 16 performs 2UP printing with the use of the data of the ledger sheet A.

After performing the 2UP print command on the computer 12A, the same user 1 transmits a 1UP print command to print the same ledger sheet A, or transmits a print command to print the same ledger sheet A with a different parameter. In such a case, the printer server 14 receives the 1UP print command to print the ledger sheet A. Having received the print command to print the same ledger sheet A with a different number of UP sheets, the printer server 14 determines that the previously transmitted 2UP print command to print the ledger sheet A is a wrong print command, and stores the data indicating the wrong print command into the print failure table. The printer server 14 then performs print control on the printer 16 to perform 1UP printing. When print commands with different parameters are issued for the same ledger sheet as described above, the printer server 14 determines that the former print command is a wrong print command, since there is a high probability that the latter print command is the command to correct the former print command that is a wrong command.

Under the print control of the printer server 14 based on the latter print command, the printer 16 performs 1UP printing. In this manner, 2UP printing and 1UP printing are both performed for the ledger sheet A, and the data indicating that the 2UP print command is a wrong print command is stored into the print failure table.

The other user 2 next transmits a print command from the computer 12B to the printer server 14 to perform 2UP printing for the same ledger sheet A. Since a print command to perform 2UP printing for the ledger sheet A is stored as a wrong print command in the print failure table, the print server 14 transmits a message to the effect that there is a possibility of a wrong print command to the computer 12B, and displays this message on the display device 28. In this manner, the printer server 14 prompts the user 2 to select either a print continue command or a print abort command. The printer server 14 then performs print control, according to the selected command.

The operation of the printer system 10 is now described in greater detail.

Referring now to FIG. 3, an example of the processing flow according to the computer processing program to be executed by the CPU 18 of the computer 12 is described.

In step 100, a check is made to determine whether a print command containing user ID has been received from an application. When such a print command has been received, print data and the parameter for performing printing based on the print data (hereinafter referred to as the printing parameter) are obtained from the application in step 102.

When such a print command is determined not to have been received in step 100, the operation is put into a stand-by state until a print command is received.

In step 104, a print data identifier for identifying the print data obtained in step S102 is attached to the user ID obtained in step 100 and the print data and the printing parameter obtained in step 102. In this manner, print job data is generated.

In step 106, the print job data generated in step 104 is transmitted to the printer server 14.

In step 108, a check is made to determine whether the later described alert message has been received from the printer server 14. When the alert message has been received, a failed print alert dialog is displayed on the display device 28 in step 110.

When the alert message is determined not to have been received in step 108, a check is made to determine whether a predetermined period of time has passed in step 112. When the predetermined period of time has passed, the CPU 18 determines that there is no alert history in the print failure history table of the printer server 14, and ends the operation. When the predetermined period of time has not passed yet, the CPU 18 determines that an alert history is still being searched for in the print failure history table of the printer server 14, and the operation returns to step 108.

The display device 28 displays an alert message such as “there is a possibility of wrong print! Please check the following setting: 2UP assignment”, a print command button, and an alert dialog showing a return button (see FIG. 2). In step 114, a check is made to determine whether a print continue command has been input by the user pressing the print button. When the print continue command has been input, the print continue command is transmitted to printer server 14 in step 116, and the operation comes to an end.

When the print continue command is determined not to have been received in step 114, the operation moves on to step 118, and a check is made to determine whether a print abort command has been input by the user pressing the return button. When the print abort command has been input, the print abort command is transmitted to the printer server 14 in step S120, and the operation comes to an end. When the print abort command has not been input, the operation returns to step 114, and the determining procedures of steps 114 through 118 are repeated until one of the commands is input.

Referring now to FIG. 4, an example of the processing flow according to the printer server processing program to be executed by the CPU 36 of the printer server 14 is described.

In step 200, a check is made to determine whether print job data has been received from the computer 12. When print job data has not been received, the CPU 36 stands by until print job data is transmitted.

When print job data has been received, the print failure table is searched for the alert information (alert history) corresponding to the print data identifier and the printing parameter contained in the print job data received from the computer 12 in the step 202.

In the print failure table, the print data identifiers (such as “DI ledger sheet 01.pdf” and “report material.doc”) are associated with printing parameters (such as “document orientation: vertical”, and “N-UP number: 2”), and printing parameters that differ between previously received print job data and later received print job data are stored as the alert information, as shown in Table 1. In the example shown in Table 1, while the number of N-UP as the printing parameters of the former received print job data is 2, the number of N-UP as the printing parameter of the latter received print job data is 1. Accordingly, “N-UP number: 2” is stored as the alert information, as the command to perform 2UP printing is determined to be a wrong print command.

TABLE 1

| print data identifier | printing parameter | alert information |
|---|---|---|
| DI ledger sheet | document orientation: vertical | N-Up number: 2 |
| 01.pdf | N-Up number: 2 | |
| | two-side printing: No | |
| | margin: regular | |
| | color mode: auto | |
| | quality: high precision | |
| | . . . | |
| report material.doc | document orientation: horizontal | document |
| | N-Up number: 2 | orientation: |
| | two-side printing: Yes | horizontal |
| | margin: regular | |
| | color mode: full-color | |
| | quality: high precision | |
| | . . . | |

In step 204, a check is made to determine whether the alert history has been searched from the print failure table in step 202. When the alert history has not been searched, a print history storing process (described later) is carried out in step 212.

When the alert history has been searched, the alert history is obtained from the print failure table in step 206.

In step 208, an alert message to that effect that there is a possibility of a print failure is transmitted to the computer 12.

A print continue command or a print abort command is transmitted from the computer according to the alert message. In step 210, a check is made to determine whether a print continue command has been received from the computer 12. When a print continue command has been received, a print history storing process (described later) is carried out in step 212. Print control is then performed on the printer 16 in step 216, and the operation comes to an end.

When a print continue command has not been received in step 210, a check is made to determine whether a print abort command has been received from the computer 12 in step 214. When a print abort command has been received, the operation comes to an end. When a print abort command has not been received in step 214, the operation returns to step 210, and the determining procedures of steps 214 and 210 are repeated until either of the two commands is input.

Referring now to FIG. 5, an example of the print history storing process carried out to store a history into the print history table and the print failure table in step 212 is described.

In step 300, the print history table shown in Table 2 is searched for the print history having the user ID and the print data identifier contained in print job data received from the computer 12. In the print history table, user IDs for identifying users, the times at which print job data are received, print data identifiers, and printing parameters contained in the print job data are associated with one another and are stored.

TABLE 2

| user ID | time | print data identifier | printing parameter |
|---|---|---|---|
| fx0519 | 2008/12/08-11:56:04 | DI ledger sheet 01.pdf | document orientation: vertical |
| | | | N-Up number: 2 |
| | | | two-side printing: No |
| | | | margin: regular |
| | | | color mode: auto |
| | | | quality: high precision |
| | | | . . . |
| fx0519 | 2008/12/08-11:59:16 | DI ledger sheet 01.pdf | document orientation: vertical |
| | | | N-Up number: 1 |
| | | | two-side printing: No |
| | | | margin: regular |
| | | | color mode: auto |
| | | | quality: high precision |
| | | | . . . |
| ff1999 | 2008/12/08-12:01:22 | ′07 report material.doc | document orientation: horizontal |
| | | | N-Up number: 2 |
| | | | two-side printing: Yes |
| | | | margin: regular |
| | | | color mode: full-color |
| | | | quality: high precision |
| | | | . . . |
| fy3908 | 2008/12/08-12:08:34 | presentation to | document orientation: horizontal |
| | | client.ppt | N-Up number: 1 |
| | | | two-side printing: Yes |
| | | | margin: regular |
| | | | color mode: monochrome |
| | | | quality: regular |
| | | | . . . |
| ff1999 | 2008/12/08-12:09:41 | ′07 report material.doc | document orientation: vertical |
| | | | N-Up number: 2 |
| | | | two-side printing: Yes |
| | | | margin: regular |
| | | | color mode: full-color |
| | | | quality: high precision |
| | | | . . . |

In step 302, a check is made to determine whether the print history searched for in step 300 exists in the print history table. When the print history does not exist, the user ID, the reception time, the print data identifier, and the printing parameter of the print job data received from the computer 12 are associated with one another and are stored into the print history table in step 314.

When the print history exists in step 302, the print history is obtained from the print history table in step 304.

When two or more print commands are issued for the same print job within a predetermined period of time, there is a high probability that the two or more print commands are issued within the predetermined period of time because the previous print command is inappropriate. When only one print command is issued for one print job within the predetermined period of time, there is a high probability that the one print command is appropriate. Accordingly, in step 306, a check is made to determine whether the received print job data is a print history stored into the print history table within the predetermined period of time, based on the time data in the print history obtained in step 304. When the reception time of the print job data is a predetermined amount of time or more past the previous reception time, the print command is determined to be an appropriate print command. The operation then moves on to step 314, and the data is stored into the print history table as described above.

When the print history obtained in step 304 is determined to be a print history stored into the print history table within the predetermined period of time since the reception of the print job data in step 306, the print command might be an inappropriate print command (a wrong print command). Therefore, the operation moves on to step 308.

In step 308, a check is made to determine whether the printing parameters contained in the print job data received from the computer 12 differ from the printing parameters contained in the print history obtained in step 304. When the printing parameters are the same, the print commands are determined to be appropriate print commands, though two or more print commands are issued for the print job within the predetermined period of time. The printing parameters contained in the print history obtained in step 304 are also determined to be appropriate printing parameters. The operation then moves on to step 314.

When the printing parameters contained in the print job data received from the computer 12 in step 308 are determined to differ from the printing parameters contained in the print history obtained in step 304, the printing parameters contained in the print history obtained in step 304 are determined to be inappropriate parameters. In step 310, the difference between the printing parameters contained in the print job data received from the computer 12 and the printing parameters contained in the print history obtained in step 304 is computed.

In step 312, the print data identifier and the printing parameters of the print history obtained from the print history table in step 304, and the printing parameters that differ from the printing parameters of the print history and have already been stored in the print history table (the printing parameters of the print job data previously designated by a print command) are stored as alert information into the print failure table, with the alert information being associated with the print data identifier.

In step 314, the time of reception from the computer 12, the printing parameters of the received print job data, and the likes are associated with the print data identifier, and are stored into the print history table.

Through the above operation, failure information is shared among network users, and printing is performed with printing parameters suitable for each document.

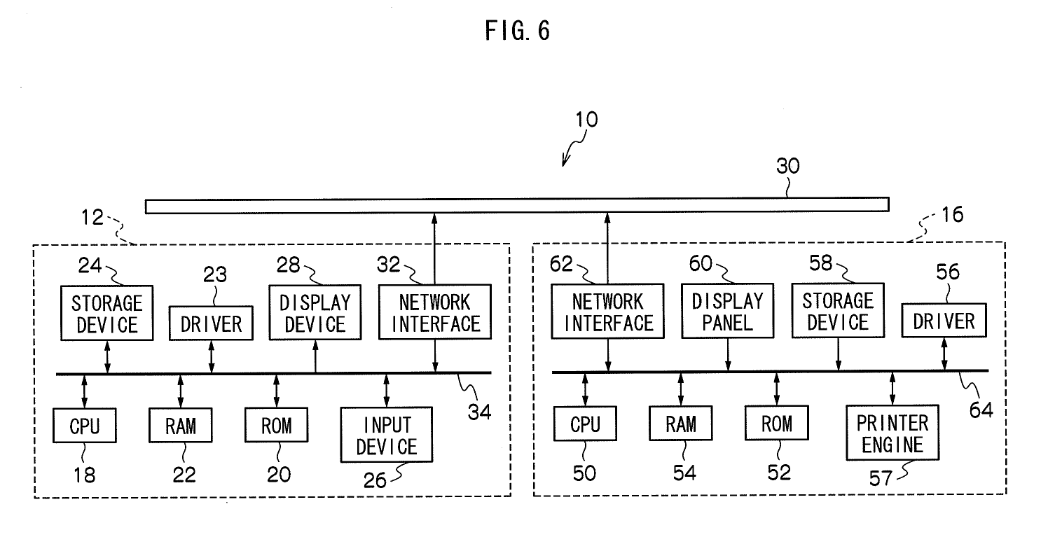

Next, a second exemplary embodiment is described. In the second exemplary embodiment, the storage device that is provided in the printer server to store the print history table and the print failure table in the first exemplary embodiment is provided in a printer, and the print history is managed in the printer. In FIGS. 6 through 8, the same components as those of the first exemplary embodiment are denoted by the same reference numerals as those used in the first exemplary embodiment, and explanation of them is omitted herein.

As shown in FIG. 6, a printer system 10 in accordance with this exemplary embodiment includes a computer 12 and a printer 16.

The device controller that controls the operation of a printer engine 57, and the print history table and the print failure table described in the first exemplary embodiment are stored in a storage device 52 in the printer 16.

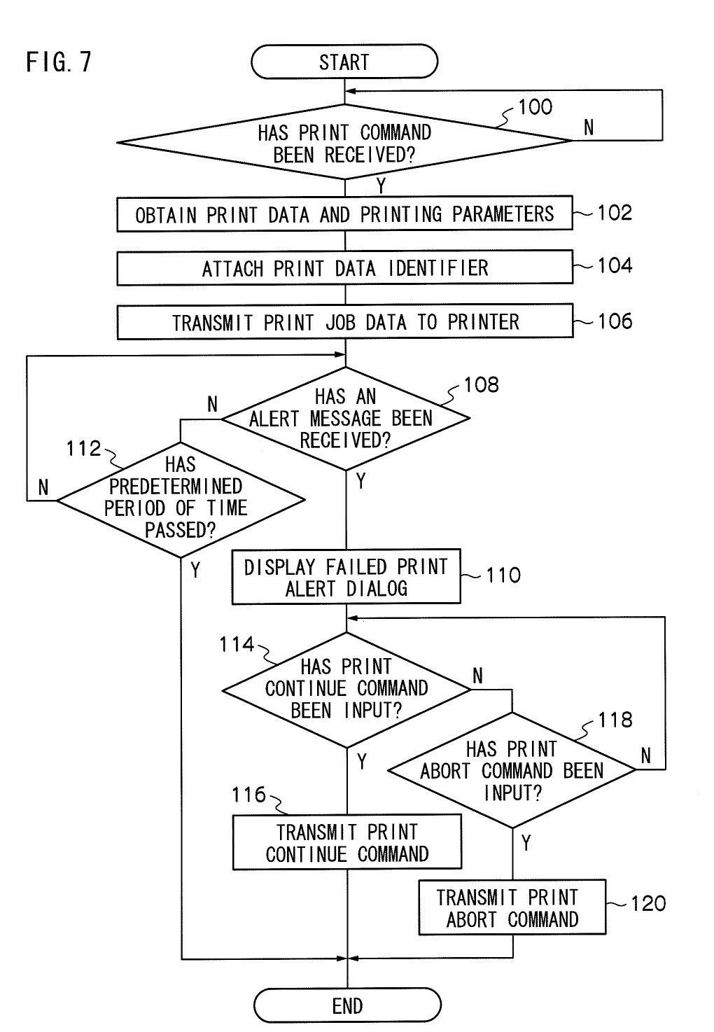

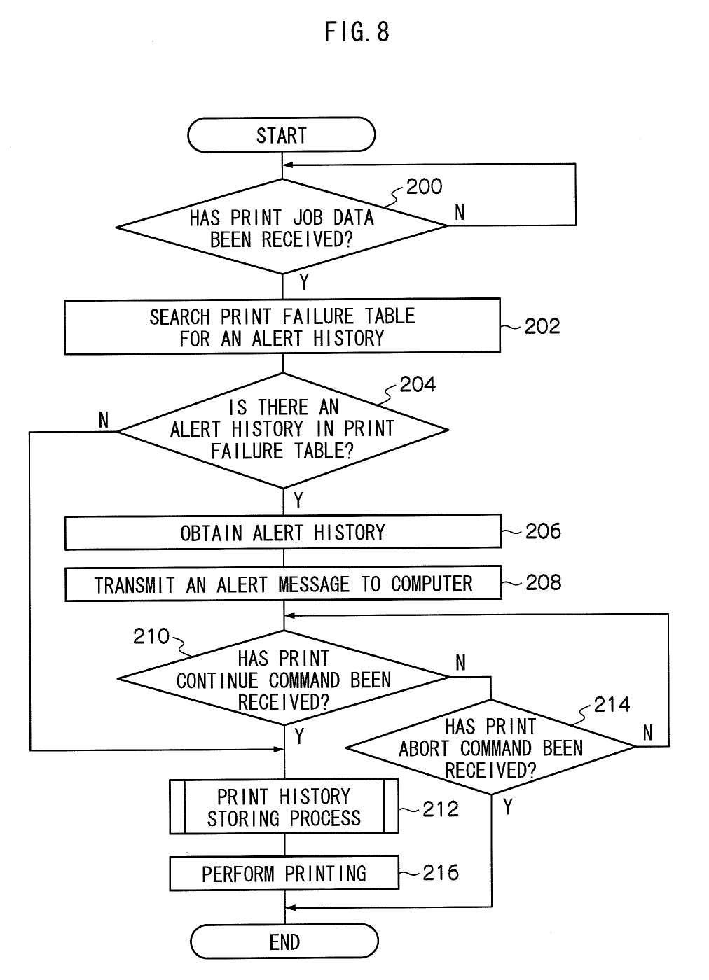

The later described processing routine illustrated in FIG. 7 is stored in a ROM 20 serving as the storage medium of the computer 12, and the later described processing routine illustrated in FIG. 8 is stored in a ROM 52 serving as the storage medium of the printer 16.

Next, the operation of the printer system 10 is described in greater detail.

Referring now to FIG. 7, a processing flow according to the computer processing program to be executed by the CPU 18 of the computer 12 is described. The differences between the second exemplary embodiment and the first exemplary embodiment include the following aspects: print jobs that are transmitted to the printer server in the first exemplary embodiment are transmitted to the printer in the second exemplary embodiment; alert messages that are received from the printer server in the first exemplary embodiment are received from the printer in the second exemplary embodiment; and print continue commands and print abort commands that are transmitted to the printer server in the first exemplary embodiment are transmitted to the printer in the second exemplary embodiment.

Accordingly, in step 106 of FIG. 7, print job data is transmitted to the printer. In step 108, a check is made to determine whether an alert message transmitted from the printer has been received. In step 116, a print continue command is transmitted to the printer. In step 120, a print abort command is transmitted to the printer.

Referring now to FIG. 8, the processing flow according to the printer processing program to be executed by the CPU 50 of the printer 16 is described. The differences between the second exemplary embodiment and the first exemplary embodiment include the following aspect: while the printer server performs print control on the printer to process print job data received from the computer in the first exemplary embodiment, the printer performs printing based on print job data received from the computer in the second exemplary embodiment.

Accordingly, in step 216 of FIG. 8, printing is performed based on print job data received from the computer.

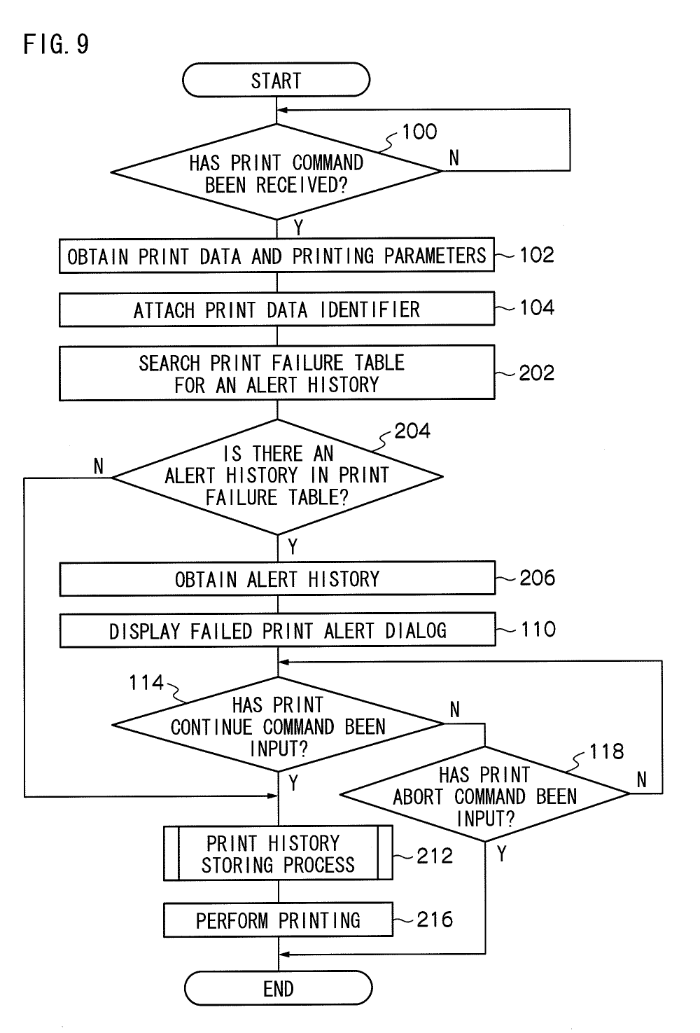

Referring now to FIG. 9, a third exemplary embodiment is described. In the third exemplary embodiment, the storage device that is provided in the printer server to store the print history table and the print failure table in the first exemplary embodiment is provided in a computer, and the print history is managed in the computer. In FIG. 9, the same components as those of the first exemplary embodiment are denoted by the same reference numerals as those used in the first exemplary embodiment, and explanation of them is omitted herein.

The printer system in accordance with this exemplary embodiment includes the same computer and the same printer as those of the second exemplary embodiment.

The printer driver for setting various functions of the OS and the printer, various application programs, the print history table and the print failure table described in the first exemplary embodiment, and the likes are stored in the storage device in the computer.

The following processing routine illustrated in FIG. 9 is stored in a ROM serving as the storage medium of the computer. Referring to FIG. 9, the processing flow according to the computer processing program to be executed by the CPU of the computer is described. The differences between the third exemplary embodiment and the first exemplary embodiment include the following aspects: the alert history search performed by the printer server based on print job data received from the computer in the first exemplary embodiment is performed by the computer in the third exemplary embodiment; the check made by the printer server to determine whether the alert history is searched in the print failure table in the first exemplary embodiment is made by the computer in the third exemplary embodiment; the obtaining of the searched alert history performed by the printer server in the first exemplary embodiment is performed by the computer in the third exemplary embodiment; the print history storing process performed by the printer server in the first exemplary embodiment is performed by the computer in the third exemplary embodiment; and the print control performed by the printer server on the printer in the first exemplary embodiment is performed by the computer in the third exemplary embodiment.

Accordingly, in step 202 of FIG. 9, the print failure table stored in the storage device in the printer is searched for the alert information (the alert history) corresponding to the print data identifier and the printing parameters obtained from an application. In step 204, a check is made to determine whether the alert history has been searched in step 202. When the alert history is determined not to have been searched in step 204, the alert history storing process is carried out in step 212. When the alert history is determined to have been searched in step 204, the alert history is obtained from the print failure table in step 206. When a print continue command is detected in step 114, the alert history storing process is carried out in step 212, and print control is performed on the printer in step 216.

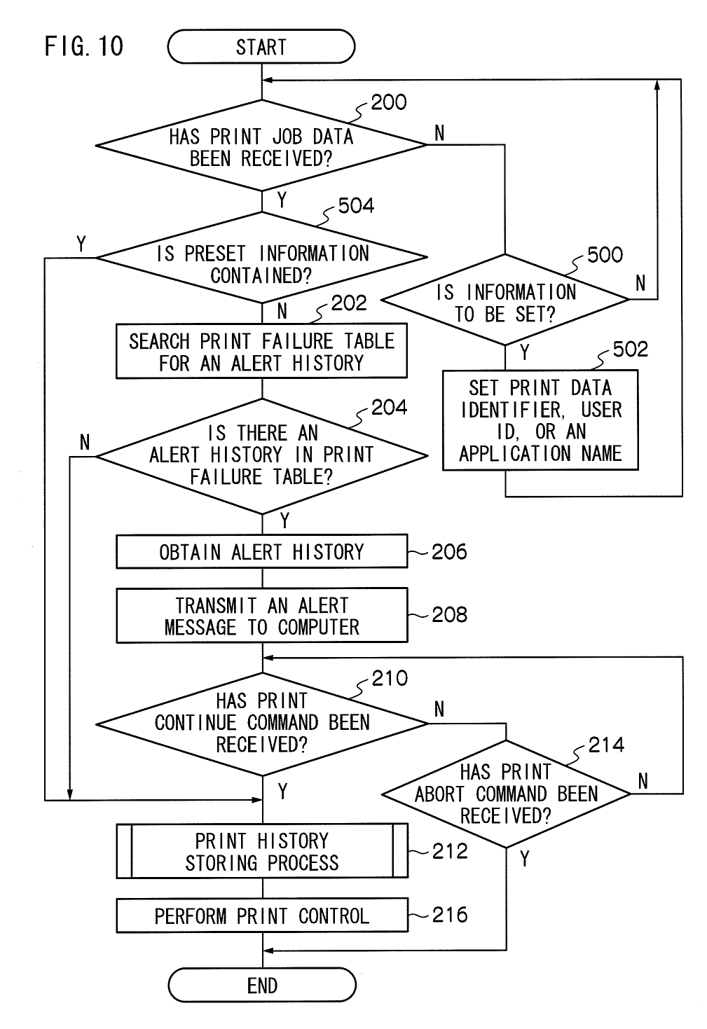

Next, a fourth exemplary embodiment is described. In the fourth exemplary embodiment, a check is made by the printer server to determine whether information set as select unnecessary information is contained in print job data received from the computer. In FIG. 10, the same components as those of the first exemplary embodiment are denoted by the same reference numerals as those used in the first exemplary embodiment, and explanation of them is omitted herein.

The structure of the printer system 10 in accordance with this exemplary embodiment is the same as the structure of the first exemplary embodiment, and therefore, explanation of the structure of the printer system 10 is omitted herein.

Next, the operation of the printer system 10 is described in detail.

The procedures according to the computer processing program to be executed by the CPU 18 of the computer 12 are the same as those of the first exemplary embodiment, and therefore, explanation of them is omitted herein.

Referring now to FIG. 10, the processing flow according to the printer server processing program to be executed by the CPU 36 of the printer server 14 is described. The differences between the fourth exemplary embodiment and the first exemplary embodiment include the following aspects: when print job data has not been received, a check is made to determine whether the print data identifier or the user ID is to be set as the select unnecessary information or the application name is set as the select unnecessary information; when the print data identifier or the user ID is to be set as the select unnecessary information or the application name is to be set as the select unnecessary information, the print data identifier or the user ID is set as the select unnecessary information, or the application name is set as the select unnecessary information; and, when the print data identifier, the user ID, or the application name is not to be set as the select unnecessary information, a check is made to determine whether a preset print data identifier or a preset user ID is contained beforehand as the select unnecessary information in the print job data received from the computer, or a preset application name is newly attached to the print job data received from the computer.

Accordingly, in step 504 of FIG. 10, a check is made to determine whether the print job data received from the computer contains the print data identifier, the user ID, or the application name that is preset in step 502. When the print job data contains the preset print data identifier, the preset user ID, or the preset application name, the print data identifier often changes the print parameter such as text data, the print command from the user does not require an alert to the effect that there is a possibility of failed printing, or it is unnecessary to display alert information, or the print command from the application is for a batch operation that is hindered by a stop of the processing. Therefore, an alert message is unnecessary, and the operation moves on to step 212. When the print job data does not contain the preset print data identifier or the preset user ID, or when the preset application name is not newly attached to the print job data, the operation moves on to step 202.

This exemplary embodiment may be applied to the second exemplary embodiment and the third exemplary embodiment.

When this exemplary embodiment is applied to the third exemplary embodiment, if a print command is not obtained in step 100 of the third exemplary embodiment, a check is made to determine whether the print data identifier, the user ID, or the application name is to be set as the select unnecessary information in step 500. When the print data identifier, the user ID, or the application name is to be set as the select unnecessary information, the print data identifier, the user ID, or the application name is set in step 502, and the operation returns to step 100. When the print data identifier, the user ID, or the application name is not to be set in step 500, the operation returns to step 100. When a print command is obtained in step 100, the print data identifier for identifying the print data is attached to the print data and the printing parameters, so as to generate print job data in step 104. After the print job data is generated in step 104, a check is made to determine whether the file name or the user ID set beforehand in step 502 or the application name set beforehand in step 502 is newly added to the print job data in step 504.

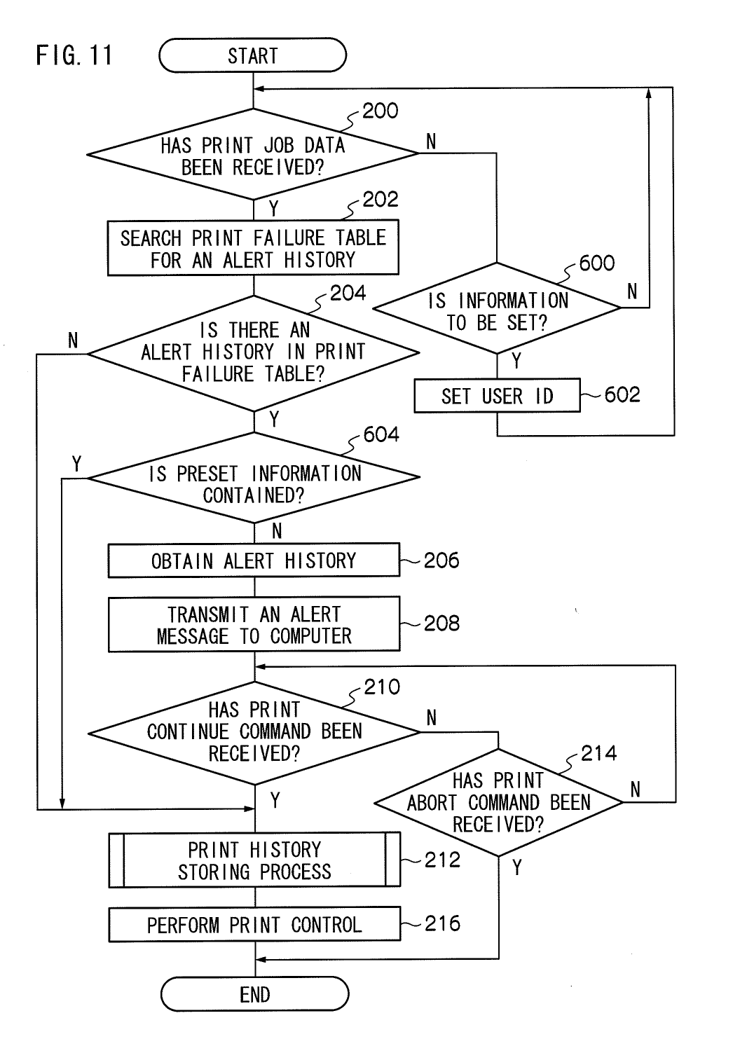

Next, a fifth exemplary embodiment is described. In the fifth exemplary embodiment, the printer server determines whether the alert history searched from the print failure table contains information that is set beforehand as the select unnecessary information. In FIG. 11, the same components as those of the first exemplary embodiment are denoted by the same reference numerals as those used in the first exemplary embodiment, and explanation of them is omitted herein.

In the printer system 10 in accordance with this exemplary embodiment, a print failure table that stores alert information associated with user IDs, print data identifiers, and printing parameters as shown in Table 3 is used in place of the print failure table stored in the storage device 44 of the first exemplary embodiment.

TABLE 3

| user ID | print data identifier | printing parameter | alert information |
|---|---|---|---|
| fx0519 | DI ledger sheet | document orientation: | N-Up number: 2 |
| | 01.pdf | vertical | |
| | | N-Up number: 2 | |
| | | two-side printing: No | |
| | | margin: regular | |
| | | color mode: auto | |
| | | quality: high precision | |
| | | . . . | |
| ff1999 | report material.doc | document orientation: | document |
| | | horizontal | orientation: |
| | | N-Up number: 2 | horizontal |
| | | two-side printing: Yes | |
| | | margin: regular | |
| | | color mode: full-color | |
| | | quality: high precision | |
| | | . . . | |

Next, the operation of the printer system 10 in accordance with the fifth exemplary embodiment is described in detail.

The operation according to the computer processing program to be executed by the CPU 18 of the computer 12 is the same as that of the first exemplary embodiment, and therefore, explanation of the operation is omitted herein.

Referring now to FIG. 11, the processing flow according to the printer server processing program to be executed by the CPU 36 of the printer server 14 is described. The differences between the fifth exemplary embodiment and the first exemplary embodiment include the following aspects: a check is made to determine whether the user ID is to be set as the select unnecessary information, and when the user ID is to be set as the select unnecessary information, the user ID is set as the select unnecessary information; and, when the user ID is not to be set as the select unnecessary information, a check is made to determine whether a preset user ID is contained as the preset information in the searched alert history.

Accordingly, in step 604 of FIG. 11, a check is made to determine whether the print job data received from the computer 12 contains the user ID that is set beforehand in step 602. When the print job data contains the preset user ID, the alert history containing the preset user ID is not used. Therefore, the operation moves on to step 212. When the print job data does not contains the preset user ID, the operation moves on to step 206.

In this exemplary embodiment, the procedure to determine whether the print job data received from the computer 12 contains the preset user ID in step 604 is applied to the first exemplary embodiment. However, this procedure may also be carried out in any of the second through fourth exemplary embodiments.

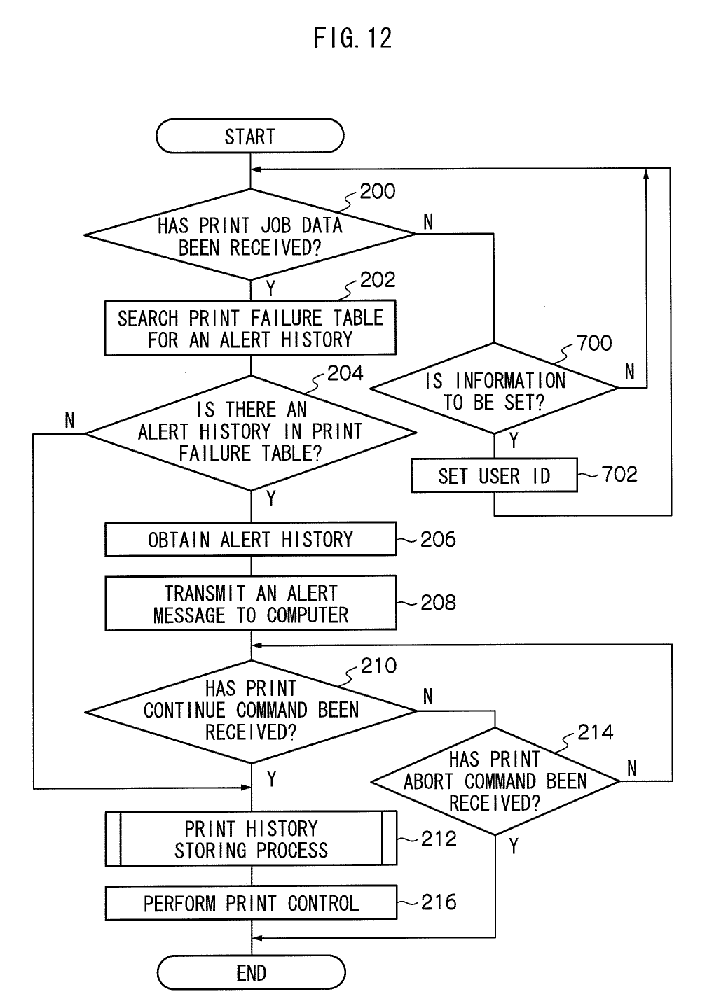

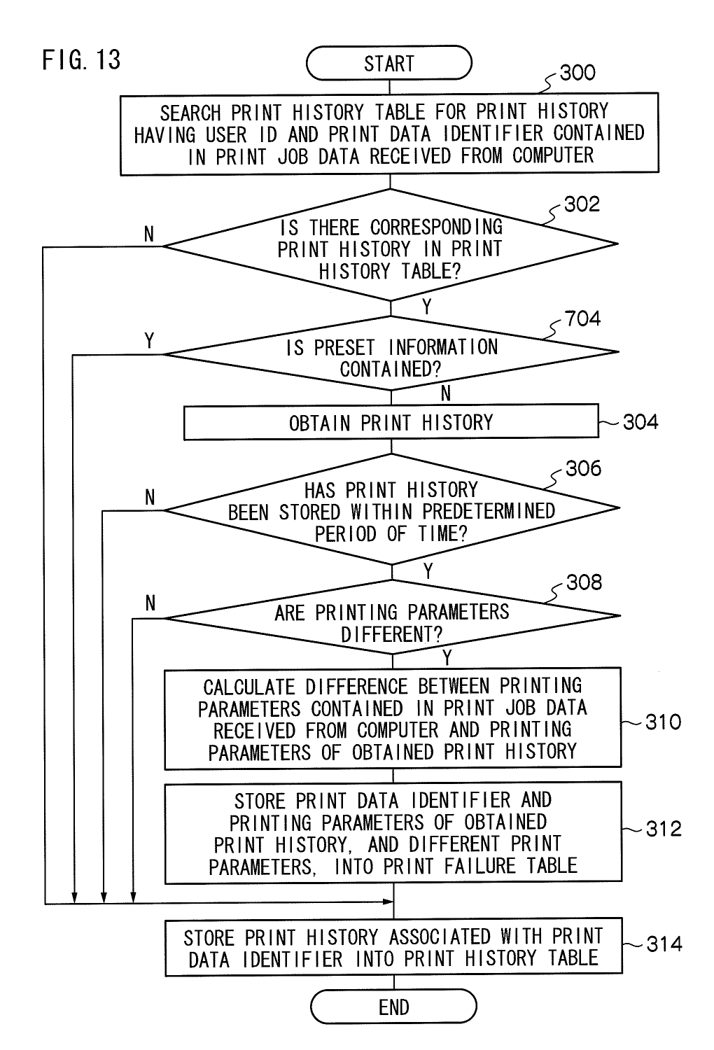

Next, a sixth exemplary embodiment is described. In the sixth exemplary embodiment, the printer server determines whether the print history searched from the print history table contains information that is set beforehand as the select unnecessary information. In FIGS. 12 and 13, the same components as those of the first exemplary embodiment are denoted by the same reference numerals as those used in the first exemplary embodiment, and explanation of them is omitted herein.

The structure of the printer system 10 in accordance with this exemplary embodiment is the same as that of the first exemplary embodiment, and therefore, explanation of the structure is omitted herein.

Next, the operation of the printer system 10 in accordance with the sixth exemplary embodiment is described in detail.

The operation according to the computer processing program to be executed by the CPU 18 of the computer 12 is the same as that of the first exemplary embodiment, and therefore, explanation of the operation is omitted herein.

Referring now to FIG. 12, an example of the processing flow according to the printer server processing program to be executed by the CPU 36 of the printer server 14 is described. The differences between the sixth exemplary embodiment and the first exemplary embodiment include the following aspect: a check is made to determine whether the user ID is to be set as the select unnecessary information, and, when the user ID is to be set as the select unnecessary information, a user ID setting process is carried out.

Accordingly, in FIG. 12, when print job data has not been received from the computer 12 in step 200, a check is made to determine whether the user ID is to be set in step 700. When the user ID is to be set, the user ID setting process is carried out in step 702, and the operation returns to step 200. When the user ID is not to be set in step 700, the operation returns to step 200. When print job data has been received from the computer 12 in step 200, the operation moves on to step 202.

Referring now to FIG. 13, an example of the processing flow according to the print history storing program to be executed by the CPU 36 of the printer server 14 is described. The differences between the sixth exemplary embodiment and the first exemplary embodiment include the following aspect: a check is made to determine whether the print history searched from the print history table contains a preset user ID that is set as predetermined information.

Accordingly, in step 704 of FIG. 13, a check is made to determine whether the print history searched from the print history table in step 300 contains the user ID that is set beforehand in step 702. When the print history contains the preset user ID, the print job data of the preset user ID is not stored into the alert history, and the operation moves on to step 314. When the print history contains the preset user ID, the operation moves on to step 304.

In this exemplary embodiment, a check is made to determine whether the preset user ID is contained. However, an IP address or a MAC address may be set, and a check may be made to determine whether the preset IP address or the preset MAC address is newly added to print job data received from the computer. When the preset IP address or the preset MAC address is contained, the alert history is not stored into the print failure table.

In this exemplary embodiment, the procedure to determine whether the preset user ID is contained in step 704 is applied to the first exemplary embodiment. However, this procedure may also be carried out in any of the second through fifth exemplary embodiments.

By carrying out the above procedures, the print job data of a user that does not benefit from print failure information is not stored as print failure information.

In each of the first through sixth exemplary embodiments, the use of the print failure information that has been stored over a predetermined period of time among the print failure information stored in the print failure table may be prohibited.

In each of the first through sixth exemplary embodiments, after the differences between the printing parameters contained in print job data received from the computer 12 and the printing parameters contained in the print history are computed, a check may be made to determine whether the number of different parameters is a predetermined number or less. When the number of different parameters is the predetermined number or less, an alert history may be stored into the print failure table.

In each of the first through sixth exemplary embodiments, the program for performing the operation of the computer, the program for performing the operation of the printer server, the program for performing the print history storing process, and the program for performing the operation of the printer are stored in a ROM in advance. However, the invention is not limited to that arrangement, and those programs may be stored in a computer-readable recording medium such as a CD-ROM, a MD, a MO, a DVD-ROM, a flexible disk, a memory card, or a DAT.

In each of the first through sixth exemplary embodiments, a dialog is displayed on the display device, so as to prompt a user to select a print continue command or a print abort command. However, a user may be prompted to select a print continue command or a print abort command through voice guidance or the like, and print control may be performed according to the selected command.

In each of the first through sixth exemplary embodiments, when there is a difference between printing parameters, the print command is determined to be a wrong print command if print job data is again received within a predetermined period of time since the print job data is received last time. However, if print job data is again received within a predetermined period of time since the print job data is received last time, the print command may be determined to be a wrong print command.

What is claimed is:

1. A print management apparatus comprising:
a first storage component that stores a print history associated with a print data identifier for identifying print data and a printing parameter to be used to perform printing based on the print data;
a second storage component that stores an alert history associated with the print data identifier and alert information;
a first control component that controls to store the print history of the print job data into the first storage component, when the print data identifier of the print job data containing the print data, the print data identifier, and the printing parameter is not stored in the first storage component;
a second control component that controls to store a printing parameter in the first storage component served as alert information into the second storage component as an alert history, when the print data identifier of the print job data is stored in the first storage component, and a printing parameter stored in the first storage component is not the same as a printing parameter of the print job data;
a select component that makes select whether continuing a print or aborting a print, when the print data identifier of the print job data is stored in the second storage component; and
a print control component that controls the printing, based on the select result of the select component.

2. The print management apparatus of claim 1, wherein the second control component controls to prohibit storing of the alert history into the second storage component, when the print data identifier of the print job data is stored in the first storage component, and a predetermined period of time has passed since the print history is stored into the first storage component.

3. The print management apparatus of claim 1, further comprising a third control component that controls to store the print history into the first storage component, when the print data identifier of the print job data is stored in the first storage component, and the printing parameter stored in the first storage component is the same as the printing parameter of the print job data.

4. The print management apparatus of claim 1, further comprising an information adding component that sets particular information contained in the print job data as select unnecessary information, or adds predetermined information as the select unnecessary information to the print job data,
wherein the select component prohibits to select continuing a print or aborting a print, when the print job data contains the set particular information, or the predetermined information is added to the print job data.

5. The print management apparatus of claim 1, further comprising an information setting component that sets particular information contained in the print job data as select unnecessary information,
wherein, when the set particular information is contained in the print job data, the select component prohibits to select continuing a print or aborting a print by not using the second storage component or not presenting a display that indicates whether continuing the print or aborting the print after using the second storage component.

6. The print management apparatus of claim 1, further comprising an information setting component that sets particular information contained in the print job data as select unnecessary information,
wherein, when the set particular information is contained in the print job data, the second control component controls not to store the alert history into the second storage component.

7. A printer system comprising:
a computer;
a server; and
a printer
wherein one of the computer, the server, and the printer includes a print management apparatus,
the print management apparatus including:
a first storage component that stores a print history associated with a print data identifier for identifying print data and a printing parameter to be used to perform printing based on the print data;
a second storage component that stores an alert history associated with the print data identifier and alert information;
a first control component that controls to store the print history of the print job data into the first storage component, when the print data identifier of the print job data containing the print data, the print data identifier, and the printing parameter is not stored in the first storage component;
a second control component that controls to store a printing parameter stored in the first storage component served as alert information into the second storage component as an alert history, when the print data identifier of the print job data is stored in the first storage component, and a printing parameter stored in the first storage component is not the same as a printing parameter of the print job data;
a select component that makes select whether continuing a print or aborting a print, when the print data identifier of the print job data is stored in the second storage component; and
a print control component that controls the printing, based on the select result of the select component.

8. The printer system of claim 7, wherein the second control component of the print management apparatus controls to prohibit storing of the alert history into the second storage component, when the print data identifier of the print job data is stored in the first storage component, and a predetermined period of time has passed since the print history is stored into the first storage component.

9. The printer system of claim 7, wherein the print management apparatus further includes a third control component that controls to store the print history into the first storage component, when the print data identifier of the print job data is stored in the first storage component, and the printing parameter stored in the first storage component is the same as the printing parameter of the print job data.

10. The printer system of claim 7, wherein the print management apparatus further includes an information adding component that sets particular information contained in the print job data as select unnecessary information, or adds predetermined information as the select unnecessary information to the print job data; and
the select component prohibits to select whether continuing a print or aborting a print, when the print job data contains the set particular information, or the predetermined information is added to the print job data.

11. The printer system of claim 7, wherein:
the print management apparatus further includes an information setting component that sets particular information contained in the print job data as select unnecessary information: and
when the set particular information is contained in the print job data, the select component prohibits to select whether continuing a print or aborting a print by not using the second storage component or not presenting a display indicating whether continuing the print or aborting the print after using the second storage component.

12. The printer system of claim 7, wherein:
the print management apparatus further includes an information setting component that sets particular information contained in the print job data as select unnecessary information: and
when the set particular information is contained in the print job data, the second control component controls not to store the alert history into the second storage component.

13. A storage medium readable by a computer, the storage medium storing a program of instructions executable by the computer to perform a function for print management, the function comprising:
(a) controlling to store a print history of print job data into a first storage component, when a print data identifier of the print job data that contains print data, the print data identifier for identifying the print data, and a printing parameter to be used to perform printing based on the print data is not stored in the first storage component that stores the print history associated with the print data identifier and the printing parameter;
(b) controlling to store a printing parameter stored in the first storage component served as an alert history into a second storage component that stores the alert history associated with the print data identifier and the alert information as alert information, when the print data identifier of the print job data is stored in the first storage component, and a printing parameter stored in the first storage component is not the same as a printing parameter of the print job data;
(c) making select whether continuing a print or aborting a print, when the print data identifier of the print job data is stored in the second storage component; and
(d) controlling the printing, based on the select result in (c).

14. The storage medium of claim 13, wherein storing of the alert history into the second storage component is prohibited in (b), when the print data identifier of the print job data is stored in the first storage component, and a predetermined period of time has passed since the print history is stored into the first storage component.

15. The storage medium of claim 13, wherein the function further comprises
(e) controlling to store the print history into the first storage component, when the print data identifier of the print job data in the first storage component, and the printing parameter stored in the first storage component is the same as the printing parameter of the print job data.

16. The storage medium of claim 13, wherein the function further comprises
(f) setting particular information contained in the print job data as select unnecessary information, or adding predetermined information as the select unnecessary information to the print job data, wherein
selecting whether continuing the print or aborting the print abort is prohibited, when the print job data contains the set particular information, or the predetermined information is added to the print job data.

17. The storage medium of claim 13, wherein the function further comprises
(g) setting particular information contained in the print job data as select unnecessary information, wherein
when the set particular information is contained in the print job data, selecting whether continuing the print or aborting the print is prohibited by not using the second storage component or not presenting a display indicating whether continuing the print or aborting the print after using the second storage component.

18. The storage medium of claim 13, further comprising an information setting component that sets particular information contained in the print job data as select unnecessary information,
wherein, when the set particular information is contained in the print job data, the alert history is not stored into the second storage component in (b).
